(19) United States
(12) Patent Application Publication
(10) Pub. No.: US 2007/0055392 A1
(43) Pub. Date: Mar. 8, 2007

(54) Method and system for model predictive control of a power plant

(76) Inventors: Fernando Javier D'Amato, Niskayuna, NY (US); Darrin Glen Kirchhof, Schenectady, NY (US); Karl Dean Minto, Ballston Lake, NY (US); Jeremy Tobias Shook, Ballston Spa, NY (US)

Correspondence Address: Patrick S. Yoder;FLETCHER YODER, P.O. Box 692289, Houston, TX, 77269-2289, US

(21) Appl. No.: 11/220,101

(22) Filed: Sep. 6, 2005

(51) Int. Cl. G05B 13/02

(52) U.S. Cl. 700/44; 700/29

(57) ABSTRACT

System and method for model predictive control of a power plant. The system includes a model for a number of power plant components and the model is adapted to predict behavior of the number of power plant components. The system also includes a controller that receives inputs corresponding to operational parameters of the power plant components and improves performance criteria of the power plant according to the model. There is also provided a method for controlling a power plant.

### BACKGROUND

The present invention relates to a system and a method of power plant control, and more particularly to model predictive control of a power plant.

Current control algorithms attempt to load (or unload) turbines, steam generators and various other components as may be applicable during load set point changes as fast as possible without violating the limits that facilitate a safe operation. However in such traditional system and method, the loading rates are typically limited by the structural constraints such as the highest stresses allowed in the rotor of a steam turbine to facilitate adequate life expenditure and operational constraints such as clearance between rotating and non-rotating parts to prevent rubbing in a steam turbine. If the loading rates for various turbines are very high, large thermal gradients may develop in the turbines leading to high stresses and uneven thermal expansion that may result in rubs. On the other hand, slow loading rates facilitate a safe operation but increase fuel costs and reduces plant availability.

Because of an inability to accurately predict conditions within a plant, typical control methods use an unduly slow standard profile to facilitate safe operation. For instance, according to the measured metal temperatures at the beginning of the startup, the current controls may categorize the start-ups as hot, warm or cold. Each of these start-up states uses loading rates slow enough to facilitate a safe operation for any startup in the same category. Consequently, such controlling methods may result in sub-optimal performance and higher operating costs. Therefore there is a need for an improved system and method for control of a power plant.

### BRIEF DESCRIPTION

Briefly, in accordance with one embodiment of the invention, there is provided a control system for a power plant. The system includes a model for a number of power plant components and the model is capable of predicting behavior of the number of power plant components. The system also includes a controller that receives inputs corresponding to operational parameters of the power plant components and improves performance criteria of the power plant according to the model.

In accordance with another embodiment of the invention, there is provided a method for controlling a power plant. The method includes building a model for a number of power plant components and the model is capable of predicting behavior of the number of power plant components. The method also includes receiving inputs corresponding to operational parameters of the power plant components and improving performance criteria of the power plant according to the model.

### DRAWINGS

FIG. 1 is a schematic diagram of an exemplary system for control of a combined cycle power plant as is found in prior art;

FIG. 2 is a schematic diagram for controller action for a power plant in accordance with one embodiment of the present technique; and

FIG. 3 is a flow chart that shows an exemplary process for improving system controls based on models in a combined cycle power plant in accordance with one embodiment of the present technique.

### DETAILED DESCRIPTION

The embodiments of the present invention comprise model predictive control systems and methods. These systems and methods may improve on real time computation and implementation of sub-optimal input profiles used for loading and unloading of various systems, subsystems and components in a power plant control system and enhance the proper models, optimizations, objective functions, constraints and/or parameters in the control system to allow the control system to quickly take improved action to regain as much performance and/or operability as possible given the current power plant condition.

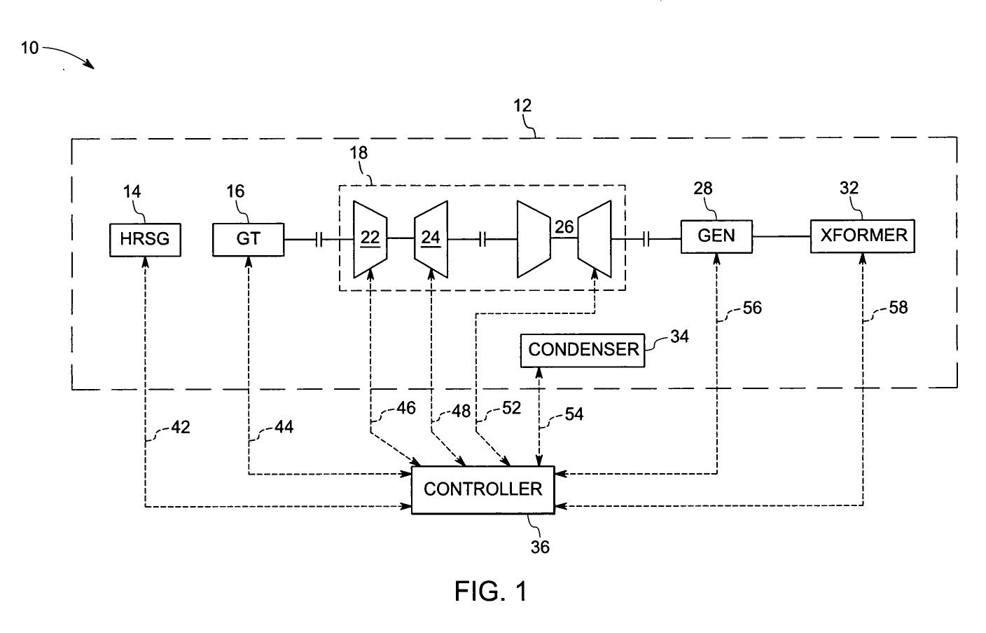

For the purpose of promoting an understanding of the invention, reference will now be made to some preferred embodiments of the present invention as illustrated in FIGS. 1-3, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the embodiments of the present invention. Any modifications or variations in the depicted model predictive control systems and methods, and such further applications of the principles of the invention as illustrated herein, as would normally occur to one skilled in the art, are considered to be within the spirit of this invention.

In embodiments of this invention, any physical system, control system or property of the power plant or any power plant subsystem may be modeled, including, but not limited to, the power plant itself, the gas path and gas path dynamics; actuators, effectors, or other controlling devices that modify or change behavior of any turbine or generator; sensors, monitors, or sensing systems; the fuel or steam metering system; the fuel delivery system; the lubrication system; and/or the hydraulic system. The models of these components and/or systems may be physics-based models (including their linear approximations). Additionally or alternatively, the models may be based on linear and/or nonlinear system identification, neural networks, and/or combinations of all of these.

Power plants are mechanical structures and installations where electricity is produced by generators powered in a variety of ways, steam turbines being the most common. Typically, in a steam turbine, heat is used to turn water to steam, which is passed through the blades of the turbine to generate rotational motion. The turbines in turn drive a shaft and turn the generators. Regardless of the source of heat, the principle of power generation remains the same. As is known to one of ordinary skill in the art, in various other instances, other sources such as coal, oil, natural gas, biomass, nuclear may be used in steam turbines. Some other known sources of electricity also use turbines, such as hydropower plants, in which turbine blades are turned by the kinetic energy of water. In other typical instances, gas turbines are used and these turbines operate by passing the hot gases produced from combustion of natural gas or oil directly through a turbine. Internal combustion engines such as diesel generators are other portable and instantaneous sources of electricity used for emergencies, and reserve. In other instances, the power generating units can utilize more than one type of fuel, for example coal or natural gas and these plants are known as duel-fired units and may be either sequentially fired or concurrently fired. Sequential plants use one fuel after the other, concurrent plants can use two fuels at the same time. Some other non-limiting examples of power plant include: fossil power plants, combined cycle power plants, nuclear power plants or the like.

FIG. 1 is a schematic diagram of an exemplary system 10 for control of an exemplary combined cycle power plant 12. The combined cycle power plant includes a heat recovery steam generator 14, a gas turbine 16 and a steam turbine 18. The steam turbine 18 has typically three sections depending on varying pressure conditions prevailing in each of them. There is a high pressure section 22, an intermediate pressure section 24 and a low pressure section 26. In addition, the power plant 12 typically includes a generator 28, a transformer 32 and a condenser 34. In operation, in the combined cycle electric power plant 12, the hot exhaust gas from the gas turbine 18 are typically supplied to a boiler or steam generator for providing heat for producing steam, which drives the steam turbine 18 through its three different sections—the high pressure section 22, the intermediate pressure section 24 and the low pressure section 26. The turbines 16, 22, 24 and 26 drive one or more electric generators 28, which produce usable electricity in tandem with the transformer 32. The gas turbine 16 is associated with the heat recovery steam generator 14, which receive condensed steam from the condenser 34 of the steam turbine 18. The electricity thus produced is supplied by an electric utility system to various industrial, commercial and residential customers.

In other combined cycle plants, further heat may be supplied to the steam generator via additional or supplemental burner mechanisms. In either case, such typical combined cycle plants 12 are relatively complex in nature and a relatively large number of sensors such as pressure transducers, proximity sensors and actuator mechanisms are provided for adjusting, regulating and monitoring the operations of the various turbines, generator and burner units and other auxiliary equipment normally associated therewith. In yet other instances of combined cycle power plants, arrangements of gas and steam turbines, steam generation sources and waste heat recovery apparatus may be employed.

Referring to FIG. 1 again, the control system 10 also includes a controller 36 to control and coordinate the activities of all the systems, subsystems and components of the power plant 12 such as the heat recovery steam generator 14, the gas turbine 16, the three sections of the steam turbine 18—the high pressure section 22, the intermediate pressure section 24 and the low pressure section 26, the generator 28, the transformer 32 and the condenser 34 and thereby to coordinate the overall functioning of the combined cycle power plant 12. In FIG. 1, the controller 36 is physically positioned outside all the systems, components and subcomponents of the power plant 12 for conceptual clarity. In another embodiment of the invention, the controller 36 may be housed inside the power plant 12 and may be interpreted as a part of the power plant 12. Structurally, the controller 36 may comprise a micro-controller or a solid-state switch configured for communication with all the power plant systems, subsystems and components in the communication network.

Communication between the controller 36 and the heat recovery steam generator 14 may take place using the communication line 42. Such communication typically includes both sensing signals carried to the controller 36 and command signals generated from the controller 36. In a like manner, communication between the controller 36 and the gas turbine 16 may take place using the communication line 44, between the controller 36 and the high pressure section 22 of steam turbine 18 may take place using the communication line 46, between the controller 36 and the intermediate pressure section 24 of steam turbine 18 may take place using the communication line 48, between the controller 36 and the low pressure section 26 of steam turbine 18 may take place using the communication line 52. In a like manner, communication between the controller 36 and the condenser 34 may take place using the communication line 54, between the controller 36 and the generator 28 may take place using the communication line 56 and between the controller 36 and the transformer 32 may take place using the communication line 58.

In operation, controller 36 monitors and controls the operational parameters in the power plant control system 10. In one embodiment, the controller 36 determines and interprets various operational parameters of the power plant control system 10 based on the sensing signals from various the systems, subsystems and components of the power plant 12 such as the heat recovery steam generator 14, the gas turbine 16, the three sections of the steam turbine 18—the high pressure section 22, the intermediate pressure section 24 and the low pressure section 26, the generator 28, the transformer 32 and the condenser 34 disposed in the power plant control system 10. The determination and interpretation by the controller 36 is done in accordance with a predetermined criterion. For instance, in one case, the predetermined criterion may include a binary comparison of the temperature of a power plant component such as the heat recovery steam generator 14 with a predetermined reference value of temperature. In another instance, the predetermined criterion may comprise comparison of the temperature of the same heat recovery steam generator 14 with a predetermined maximum value of temperature. In yet another instance, the predetermined criterion may comprise comparison of the temperature of heat recovery steam generator 14 with a predetermined minimum value of temperature.

Depending on a number of operational parameters sensed and determined at various sensing points in the power plant 12 as explained above, the controller 36 monitors and controls the input loading and unloading profiles of various subsystems and components of the power plant 12 such as the heat recovery steam generator 14, the gas turbine 16, the three sections of the steam turbine 18—the high pressure section 22, the intermediate pressure section 24 and the low pressure section 26, the generator 28, the transformer 32 and the condenser 34 so that the appropriate operating conditions of the power plant 12 and all its subsystems and components are maintained during a typical operation cycle of the power plant 12 and the power plant control system 10.

Whatever be the criterion for comparison, if the loading or unloading rates in any of the systems, subsystems or components of the power plant 12 falls outside of the predetermined reference range for safety, the controller 36 may determine that the loading or unloading status of the relevant subsystem or component is not acceptable and the subsystem or component needs additional corrective control actions. In that event, the controller 36 sends appropriate command signals to the relevant subsystem or component and regulates the input profiles for loading or unloading of the relevant subsystem or component. The resulting loading or unloading rate of the relevant subsystem or component is thereby corrected to be safe and accurate. In another embodiment, if the controller 36 senses that some subsystem or component needs extra corrective control action, it sends an alarm signal to the alerting system and the alerting system in turn generates an appropriate alarm to a process observer at a remote location to take suitable action.

The present technique relates to a systematic approach to accommodating inputting optimal loading or unloading profiles in real time in the power plant 12 and the systems, subsystems and the components of the power plant 12. This accommodation is accomplished in part by updating the states and parameters of the models in a model predictive control system based on sensor measurements. State updates in a typical model predictive control system accounts for changes in the plant operation, like steam temperature rise due to increased fuel flow. Parameter updates in a typical model predictive control system may account for component-to-component variation, deterioration, mechanical, electrical or chemical faults, failures, or damage to the turbine or generator or any of the turbine or generator components, and mechanical, electrical or chemical faults, failures or damage to the control system and/or its components.

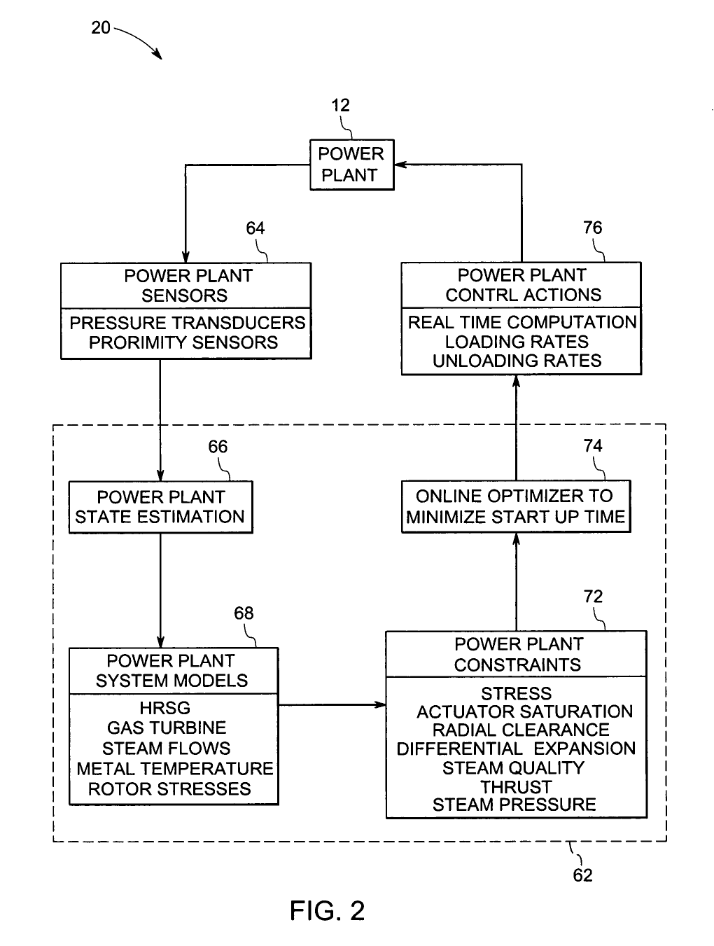

FIG. 2 is an exemplary schematic diagram for controller action for the combined cycle power plant 12 of FIG. 1 in accordance with one embodiment of the present technique. A controller 62 is equipped with necessary hardware components and model predictive software algorithm of the present technique to enable optimal loading and unloading of the systems, subsystems and components of the power plant 12 of FIG. 1. Within the functional block denoting the controller 62, the functional block 64 illustrates the action of multiple sensors coupled with various systems, subsystems and components of the combined cycle power plant 12. Based on the sensing signals from the sensors, state estimation of the combined cycle power plant 12 is carried out by the controller 62 as illustrated in functional block 66.

Based on the state estimation, system models of the combined cycle power plant 12 are built by the controller 62 as illustrated in functional block 68. At the same time, system constraints of the combined cycle power plant 12 are taken into consideration as illustrated in functional block 72 for building the system models as illustrated in functional block 68. In functional block 74, an online-optimizer does a real time model predictive optimization of the input loading and unloading profile of the combined cycle power plant 12. Details of the model predictive optimization algorithm will be presented later. Finally, in functional block 76, the control cycle of the combined cycle power plant 12 is completed with appropriate control actions as commanded by the controller 62.

The invention is not limited to the above mentioned combined cycle power plant 12 as a whole specifically. In other embodiments of the invention, the estimator(s) and the optimizer(s) may determine the objective function(s), constraint(s), and model(s) of the other systems, subsystems and components to be used by the model predictive control. A typically logic function of the system of FIG. 2 may receive information from both a diagnostic function and an operator or a supervisory controller. This information may then be processed to determine the correct form of the relevant objective function(s), constraints, and models. The logic functionality is described here in relation to the complete power plant 12, but it could be generalized to real time control and management of optimal loading and unloading of all its systems, subsystems and components as is described below.

In one embodiment, the controller 62 comprises an analog-to-digital converter accessible through one or more analog input ports. In another embodiment, the controller 62 may include read-out displays, read-only memory, random access memory, and a conventional data bus. In one embodiment of the invention, the sensors installed over the systems, subsystems and the components of the power plant 12 typically communicate to the controller 62 using at least one standard communication protocol such as a serial or an ethernet communication protocol.

As will be recognized by those of ordinary skill in the art, the controller 62 may be embodied in several other ways. In one embodiment, the controller 62 may include a logical processor, a threshold detection circuitry and an alerting system. Typically, the logical processor is a processing unit that performs computing tasks. It may be a software construct that comprises software application programs or operating system resources. In other instances, it may also be simulated by one or more physical processor(s) performing scheduling of processing tasks for more than one single thread of execution thereby simulating more than one physical processing unit. The controller 62 aids the threshold detection circuitry in estimating different operational parameters such temperature, pressure, stress level, fatigue level of the system, sub-systems and components of the power plant 12 such as the heat recovery steam generator 14, the gas turbine 16, the three sections of the steam turbine 18—the high pressure section 22, the intermediate pressure section 24 and the low pressure section 26, the generator 28, the transformer 32 and the condenser 34.

In one embodiment of the invention, in relation to the operation of the whole power plant 12, operational parameters related to the operation of valves in a steam turbine or operational parameters related to supply water valves operation in a heat recovery steam generator or typical rotor stress are tracked by the controller 62. In another embodiment of the invention, in relation to the gas turbine 16, quantity of fuel flow, operational parameters related to inlet guide vanes operation for the steam turbine 18 may be tracked. Moreover, the input profile for loading and unloading of the gas turbine 16 is adjusted in such a way that high thermal gradient does not set in. The controller 62 continuously tracks a number of sensing signals coming from the gas turbine 16, the steam turbine 18 and other such components and operates such that these operational parameters of the components and the power plant 12 as a whole are within safe and optimal control limits.

An important idea with respect to the use of model predictive controls is to use the model predictions of the performance over time intervals ranging from few seconds to few hours, to optimize input loading profiles from any initial load to any final load via constrained optimization, starting from the current system state of a start-up. Generally speaking, model predictive control is a control paradigm used to control processes that explicitly handles the, physical, operational, safety, and/or environmental constraints while maximizing a performance criterion.

The model(s) in the control system 20 may be built using a suitable method to modify states, variables, quality parameters, constraints, limits or any other adaptable parameter of the models so that the performance and limitations of the models match that of the physical turbine or generator after the parameter is changed. Using the information about any detected changes, together with the updated model, the model predictive control system 20 is able to evaluate the current and future conditions of the power plant 12 and its systems, subsystems and components and take a more optimized control action than would have been possible if the models had not been updated and if such information had not been passed to the control system. One advantage of these systems and methods is that, since they can be updated in real-time, they allow for optimal loading calculations for any range of initial states of the components, not just finite set of sub-optimal, standard loading profiles already programmed into the control system. In an exemplary situation, the prediction horizon during a start up may typically range from 5 min to 2 hours.

Controlling the performance and/or operability of a combined cycle power plant 12 of FIG. 1 requires analyzing multiple variables to determine the appropriate control values that are needed to produce the desired output. These multiple variables can affect each other in a nonlinear manner, and thus should be operated on accordingly. Creating model(s) to represent the various effects that multiple variables have on each other within a specific system can be difficult when accuracy and response speed are important, such as with modern power systems Since not every eventuality is likely to be covered in such models, it is desirable for such models to reconfigure, adapt and learn to make predictions or corrections based on turbine or generator sensor data. In one embodiment of this invention, such adaptability for normal or sub-optimal loading and unloading conditions comes from a state estimator to calculate the current state of various models such as models of steam temperatures, pressures, metal temperatures, or the like. In another embodiment of this invention, adaptability may come from a diagnosis algorithm or system to detect faults or malfunction in sensors, actuators or any other component of the power plant 12. In a further embodiment of the invention, such adaptability for sub-optimal loading and unloading conditions may also come from using the sensor based diagnostics, which can select between different models, modify model inputs, outputs, or interior parameters, or can modify the optimizations, objective functions, constraints, and/or parameters in the control. Then, given the modified models, optimizations, objective functions, constraints and/or parameters, a computationally efficient optimizer may be used so that improved performance and/or operability can be obtained.

Strong nonlinearities are present in various subsystems and components of the power plant 12 due to the large range of operating conditions and power levels experienced during operation. Also, operation of power plant 12 is typically restricted due to various mechanical, aerodynamic, thermal and flow limitations. In one embodiment of the invention, model predictive controls are ideal for use for such environments because they can specifically handle the nonlinearities, and both the input and output constraints of many variables, all in a single control formulation. Model predictive controls are typically feedback controls that use models of the process/system/component to predict the output up to a certain instant of time, based on the inputs to the system and the most recent process measurements.

The models in the model predictive controls of this invention are designed to replicate both transient and steady state performance. These models can be used in their nonlinear form, or they can be linearized or parameterized for different operating conditions. Typical model predictive control techniques take advantage of the models to gain access to parameters or physical magnitudes that are not directly measured. These controls can be multiple-input multiple-output (MIMO) to account for interactions of the control loops, they can be model-based or physics based and they can have limits or constraints built as an integral part of the control formulation and optimization to get rid of designing controllers modes or loops for each limit. The current strategy for this invention involves calculating the actions of the controller 62 based on a set of objective function(s) and a set of constraint(s) that can be used as part of a chosen optimization objective. Typical objective function(s) may include various performance criteria such as minimization of startup time, minimization of fuel costs, minimization of emissions, maximization of plant operability and the like. Typical constraints considered may include mechanical constraints, thermal and other stresses developed in different systems, subsystems and components of the power plant 12 such as thrust force at the bearings, actuator saturation, radial clearances between various rotating parts, differential expansion between various adjoining parts, maintenance of steam quality, maintenance of water level in boilers, and steam and metal temperatures and steam pressures at different locations/components in the combined cycle power plant 12.

In order to detect smaller sub-optimal operating conditions and to make enhanced control decisions, the control system 20 preferably has as much input information as possible about the power plant 12 and its subsystems and components that it is controlling. One of the best ways to gain this input information about the system is to use dynamic models. Doing this provides information about how different operating parameters of the power plant 12 should respond given the current ambient conditions and actuator commands, the relationships between parameters in the system, the relationships between measured and unmeasured parameters, and the parameters that indicate the overall start-up status of the power plant 12. If the models are dynamic, then all this information is found on both a steady state and transient basis. The models can also be used to analyze a profile of past measurements or current performance, or it can be used to predict how the power plant 12 will behave over a specific time horizon.

In one embodiment of the invention, the models may be physics-based, and/or system identification-based. In another embodiment of the invention, the models may represent each of the main components of the power plant 12 at a system level, including for example the heat recovery steam generator 14 with and without additional firing unit, the gas turbine 16, the high-pressure section 22 of the steam turbine 18, intermediate pressure section 24 of the steam turbine 18, low pressure section 26 of the steam turbine 18, the generator 28, the transformer 32, the condenser 34 and the like. In yet other embodiments of this invention, the nominal turbine or generator or subsystem steady state and transient performance may be recreated and used inside the model predictive control and its estimator (not shown) or an optimizer. Other embodiments may use models with faulted, failed, or sub-optimally operating characteristics in a single or multi-model optimality diagnostic system.

As each component of the power plant 12 is different and may operate at different levels of optimal or sub-optimal conditions, the models should be able to track or adapt themselves to follow such changes. The models should preferably reveal current information about how a particular component is running at a given time, specifically at the time of start-up. This allows the behavior of the power plant 12 to be more accurately predicted, and allows even smaller sub-optimalities of the power plant 12 to be detected. Various parameters and states of the power plant 12 are two areas of the models that can be modified to match the model of the power plant 12 to the current status. A parameter estimator may be used in conjunction with the controller 62 to determine the turbine or generator parameters, and a state estimator may be used to determine the states.

In another embodiment of the invention, a state estimator may be used to further aid in tracking the models of the gas turbine 16 or any other system or subsystem or component or the whole power plant 12. The state information may also be used to initialize the model predictive controller 62 at each time interval. Since the model predictive controller 62 can use the estimate of the current state of the turbine or generator to initialize and function correctly. The goal of a state estimator is to estimate the states of the models with the lowest error as compared with the actual system, given the model dynamics. By using the state estimator, which may include information about the dynamics of the power plant 12 and the noise from various sensors, a much more accurate value for the actual position can be determined. These same types of results can be applied to a gas turbine 16 or any other system or subsystem or component or the whole power plant 12 in real time during both steady state and transient turbine or generator operation.

There are different methods for the optimizer to adopt depending on the needs of the optimization problem. In one embodiment of the invention, active set methods may be used to solve the quadratic programming formulations. This approach is typically very efficient for relatively smaller problems with lower number of constraints. In another embodiment of the invention, a sequential quadratic programming (SQP) approach may be used, in which the relevant system is periodically linearized within the prediction horizon to produce a version of problem with fixed, but not necessarily equal realization elements for every step of optimization. The solution of the resulting problem is then used to re-linearize within the same prediction horizon and the process is repeated for convergence till a satisfactory solution emerges.

In another embodiment of the invention, interior point (IP) methods may be used for solving constrained quadratic programming problems arising in model predictive control designs. Typically, the interior point formulations perform relatively fast in the presence of large number of (inequality) constraints. In one such embodiment of the invention, at any give step of the iterative process, an interior point algorithm arrives at a feasible solution within a reasonably short time giving the system an advantage of real time response and control. In another instance, if for some reason the algorithm cannot run to completion, it will produce a control action that may not be optimal, but that satisfy the constraints. In one such embodiment of the invention, there are theoretical bounds for the number of iterations typically used to achieve a solution within any given range of accuracy for every instance of the problem. These bounds typically associate polynomial complexity with the corresponding algorithms, that is, the computational effort to solve quadratic programming problems does not grow faster than polynomially with the problem size. In addition, these theoretical bounds may be well within the solution horizon depending on a number of situational factors. Such factors may typically include the nature of the optimization problem, the system dynamics, the bandwidth of the models, the particular algorithms chosen, the constraints related to the problem and the like. Typically an efficient problem formulation makes the solution amenable to be used in real time and the basic utility of model predictive algorithm may be owing to its ease and appropriateness for being used in real time.

In operation, in all the different alternative model predictive control formulations, the equality constraints in the problem are either used explicitly while solving the optimization problem, or used to eliminate variables so that the resulting quadratic programming formulation have significantly less optimization variables. The typical matrix and vector transformations as part of this elimination of variables may alter the structure in the data of the original problem affecting potential computational savings. The convenience of one formulation over the other however, depends on the specific problem, the quadratic programming algorithm approach used and its ability to exploit a relevant problem structure.

An interior point method is an iterative process that involves taking successive steps until the solutions converge. At each iteration, a great deal of computational effort is spent solving linear equations to find a suitable search direction. There are various algorithms that are classified as interior point algorithms. They may have similar or close to similar performance measures. The use of a particular algorithm is often decided by the scale, accuracy and speed of the solution required.

In one embodiment of the invention, where the state variables and hence the equality constraints are not eliminated, the coefficient matrices used for typical model predictive control formulations may be sparse. This property of sparsity may be utilized to drastically reduce computations. Typically, power plant control problems such as determining input profiles for optimal loading and unloading in real time are highly structured optimization problems in nature. The structure of these optimization problems consists mainly in the sparsity structures in problem data, and can be used to get drastic reductions in computational efforts. There are various levels of sparsity structures that may be deployed to make the solution fast. In one embodiment of the invention, sparsity in the optimization problem data is exhaustively exploited to accelerate calculation of the optimal solution and reduce memory requirements.

The objective function in a model predictive control optimization problem in one embodiment of this invention is a mathematical way of defining the goal of the control system. The objective function determines what is defined as optimal. Some general objective functions are to minimize fuel consumption, maximize turbine or generator life, follow reference pressures, minimize time to achieve, a predetermined power level, follow reference of pressure ratios, minimize emission of pollutants, follow reference power, follow reference speed, minimize or maximize actuator command(s), follow reference flow(s), minimize costs or the like. In various embodiment of the invention, as mentioned earlier, the optimization algorithm used inside the model predictive controller 62 may be constrained or unconstrained.

Model predictive control with estimation gets performance and/or operability gains over conventional controls by accounting for component-to-component variation, sub-optimal loading or unloading, schedule approximations, and changes in the configuration of the power plant components. It also get performance and/or operability gains: (1) from being nonlinear and MIMO (which yields a coordinated action of a multiplicity of actuators to improve plant operation); (2) from being model-based (which yields lower margin requirements by running to updated model parameters); (3) from its predictive nature (which yields loading paths shaping to improve performance while observing all the constraints); and (4) from its updatable constraints (which enhances operability).

Control systems in typical combined cycle power plants 12 of FIG. 1 that operate in accordance with an embodiment of the present invention may provide direct control of variables of interest, such as rotor stresses and clearances or the like instead of indirect control of such variables. They explicitly handle constraints without the need for additional, complex logic and they explicitly deal with the MIMO nature of the detected problem.

Whatever algorithms are used for model predictive control problems, the solution of constrained quadratic programming problems of the form where the realization elements are fixed, is an important aspect of model predictive control. In the present embodiments of the invention, various efficient software tools are used for solving constrained quadratic programming problems and implementing model predictive control in controller 62 in an automated real time fashion. The software packages developed for model predictive control implementations take advantage of the highly-structured problem data in the context of a power plant application to produce efficient codes suitable for fast, real-time implementation.

The current software implementation exploits the sparsity structure mentioned above. A sparsity structure that is common to problems may be determinable since it depends only on the problem sizes, like number of constraints and prediction horizon. In operation however, the sparsity structure is dependent on specific problems and it is determined automatically during the initialization stage for every problem. To elaborate, the system is linearized during the initialization to calculate the dense realization matrices. At this stage, the size of every entry in the coefficient matrices typically used is compared against a threshold (i.e. 10-14) to determine if it is zero or non-zero. The sparsity structure found in this way is then used throughout the model predictive control method to reduce the computational effort.

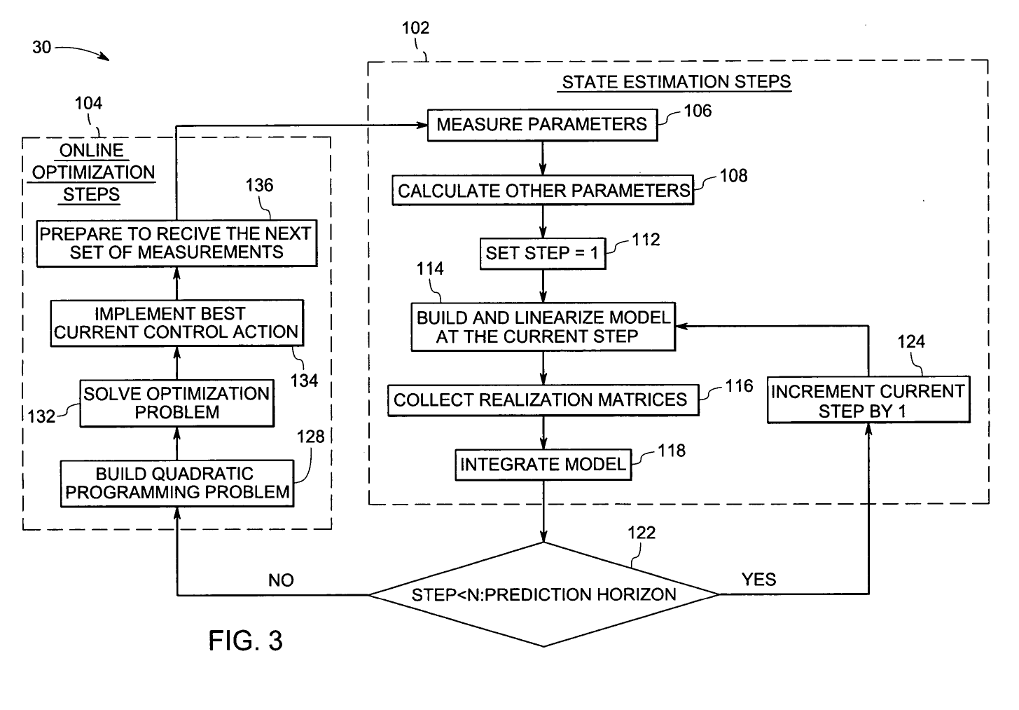

FIG. 3 is a flow chart 30 that shows an exemplary process for improving system controls for loading and unloading of the input profiles of the systems, subsystems and components of the power plant 12 of FIG. 1 in real time based on models in a combined cycle power plant in accordance with one embodiment of the present technique. The method begins with the state estimation steps as illustrated in functional block 102. Various operational parameters such as steam and gas temperatures, pressures and flows, fuel and airflow, metal temperatures, actuator position are measured as in functional block 106. In the next step, magnitudes of the parameters that are not easy to be measured directly are calculated as in functional block 108. Examples of such parameters may include metal temperatures in steam turbine shells and rotors. The algorithm, in the next step, equates the current step to 1 as in functional block 112 and proceeds to build and linearize models that represent dynamics of gas turbine loading and its effects on steam turbine constraints at the current step as in functional block 114. Realization matrices are collected in the next step to build optimization problems as in functional block 116. Models are further integrated in the optimization problems to predict system state in the next time step as in functional block 118.

At this stage, the algorithm does an internal checking to ascertain whether a step corresponding to the predefined prediction horizon of the optimization problem and enumerated as ‘N’ has reached as in functional block 122. In case the ‘N’th step is reached, the current step is incremented by 1 as in functional block 124. The control goes back to functional step 114 described above for the next iteration.

Referring to FIG. 3 again, at the end of functional block 122, by internal checking if it is ascertained that the ‘N’th step is not reached yet, online optimization steps are followed as in functional block 104. Quadratic programming problems are built with collected realization matrices as in functional block 128. An online optimizer solves the optimization problem as in functional block 132. In the next step, the best current control action is implemented as in functional block 134 and the optimization program prepares to receive the next set of measurements as in functional block 136. Following this, the control goes back to functional block 106 described above for the next iteration.

Referring to FIG. 3 once more, the control sequences represent a generic set of steps typically followed in a large number of situations. In any particular instance however a suitable set of control sequences may be determined by converting the optimization problem of the power plant 12 in general as illustrated in the embodiment of the invention of FIG. 3 into a form that the corresponding optimization algorithm is capable of solving. In one embodiment of the invention, for instance, typical realization elements may be assumed constant within a prediction horizon, and may be computed in advance the for an overall prediction horizon. In this approximation, the resulting optimization problem is a quadratic programming problem with equality and inequality constraints, rendering itself to an efficient solution. In another embodiment of the invention, the optimization problem may be solved using a linear programming method.

The information about the current state of the power plant 12 may comprise information about the turbine or generator itself, a turbine or generator component, an turbine or generator system, a turbine or generator system component, a turbine or generator control system, an turbine or generator control system component, a gas/steam path in the turbine or generator, gas/steam path dynamics, an actuator, an effector, a controlling device that modifies turbine or generator behavior, a sensor, a monitor, a sensing system, a fuel metering system, a fuel delivery system, a lubrication system, a hydraulic system, component-to-component variation, deterioration, a mechanical fault, an electrical fault, a chemical fault, a mechanical failure, an electrical failure, a chemical failure, mechanical damage, electrical damage, chemical damage, a system fault, a system failure, and/or system damage. The models in these systems and methods may comprise a physics-based model, a linear system identification model, a nonlinear system identification model, a neural network model, a single or multivariable simplified parameter model, a single input single output model, a multiple input multiple output model, and/or any combinations of these models. Updating may comprise updating, adapting or reconfiguring a state, a variable, a parameter, a quality parameter, a scalar, an adder, a constraint, an objective function, a limit, and/or any adaptable parameter of the models or control during steady state and/or transient operation. Diagnostics occur using heuristic, knowledge-based, model-based approaches, and/or multiple-model hypothesis. The models may be updated/adapted by using a linear estimator, a non-linear estimator, a linear state estimator, a non-linear state estimator, a linear parameter estimator, a non-linear parameter estimator, a linear filter, a non-linear filter, a linear tracking filter, a non-linear tracking filter, linear logic, non-linear logic, linear heuristic logic, non-linear heuristic logic, linear knowledge base, and non-linear knowledge base or other suitable method. The control command may be determined by constrained or unconstrained optimizations including: linear optimization, nonlinear optimization, convex optimization, non-convex optimization, linear programming, quadratic programming, semi-definite programming, methods that use sparsity structures in problem data to reduce computational effort, and/or gradient decent optimization methods. The operations are preferably performed automatically by a computer or computing device to optimize either the performance and/or the operability of the turbine or generator.

The invention is not limited to only the above-mentioned functions of the controller 62 such as optimizing loading and unloading input profiles during start-up of the power plant 12. In other embodiments of the invention, the functions of the controller 62 may include other real time operations such as prediction, detection and prevention of any level of deterioration, faults, failures or damage in various systems, subsystems and components of the power plant 12. In another instance, the real time execution rate of the controller 62 is configurable to adapt to different sizes of the models. In another instance, the real time execution rate of the controller 62 is also configurable to adapt to various other of optimization algorithms.

In another embodiment of the system, instead of directly controlling and monitoring various systems, subsystems and components of the power plant 12, the controller 62 may communicate with a number of local controllers and processor installed in various systems, subsystems and components of the power plant 12. Examples of such local controllers and processor may include a gas turbine controller, a steam turbine controller, a heat recovery system generator controller, a standalone processor communicating with the gas turbine controller, a standalone processor communicating with the steam turbine controller or a standalone processor communicating with the heat recovery system generator controller.

In yet another embodiment of the invention, the power plant 12 may be a fossil plant or a nuclear plant. Whatever be the configuration of the power plant 12, typically, steam turbine plants, either from combined cycle power plants or nuclear plants or fossil plants, may be subject to stress constraints in the rotor. Such stress constraints may come typically at the rotor bore and at the rotor surface, differential expansion constraints in the direction of the axis of the rotor to prevent axial rubs and radial clearance constraints to prevent radial rubs due to differential expansion in the direction perpendicular to the rotor. Typical operations of nuclear and fossil plants may also be subject to similar constraints in maintaining the water level of steam generators. In addition, fossil plants must also account for emission constraints. Other constraints specific to fossil plants may include temperature limitations to prevent slag formation or slag build-up. For a typical estimation problem in fossil plants, it may be important to get online fuel composition or quality estimation, and also an indication of the level of slagging and fouling in the furnace tubes, since that may largely affect the heat transfer to the water/steam tubes. The objective function applicable in case of fossil or nuclear plants may be similar to the ones applicable for combined cycle power plants. In an exemplary embodiment of the invention, control actions for fossil plants may include measures such as total fuel flow, total air flow or fuel/air ratio, individual fuel and airflows at individual burners or at a set of burners and the like. In another instance, specifically in the context of a nuclear power plant, there may be steam quality limitation existing to prevent erosion.

Various embodiments of the invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the embodiments of the present invention. For example, while this invention has been described in terms of steam turbine engine control systems and methods, numerous other control systems and methods may be implemented in the form of a model predictive control as described. Thus, it is intended that the embodiments of the present invention cover all suitable modifications and variations as come within the scope of the appended claims and their equivalents.

While only certain features of the invention have been illustrated and described herein, many modifications and changes will occur to those skilled in the art. It is, therefore, to be understood that the appended claims are intended to coverall such modifications and changes as fall within the true spirit of the invention.

1. A control system for a power plant, comprising:
a model for a plurality of power plant components, the model adapted to represent dynamics and a plurality of constraints of the plurality of power plant components using a plurality of parameters, the model being adapted to predict behavior of the plurality of power plant components; and
an optimizer that is adapted to receive input corresponding to the plurality of parameters and to generate input profiles of the plurality of plant components that satisfy the plurality of constraints and to optimize performance criteria for the plurality of plant components.

2. The system according to claim 1, wherein the model comprises a plurality of physics-based models.

3. The system according to claim 1, wherein the plurality of constraints comprise at least one of: mechanical constraints, thermal constraints, stresses, thrust force at a plurality of bearings, actuator saturation, radial clearances between a plurality of rotating parts and stationary parts, differential expansion between a plurality of adjoining parts or maintenance of at least one of: steam quality, water level in boilers, steam temperature, metal temperature or steam pressure at a plurality of locations in the power plant.

4. The system according to claim 1, wherein the inputs comprise at least one of: a quantity of fuel flow corresponding to one or more gas turbines or steam generation units, at least one parameter related to inlet guide vanes operation for the power plant corresponding to one or more gas turbines, at least one parameter related to a feed water or blow down valves operation in the heat recovery steam generator, at least one parameter related to operation of a valve in a steam turbine, at least one parameter related to steam attemporation in the heat recovery steam generator, or at least one parameter related to vacuum pumps in the condenser.

5. The system according to claim 1, wherein the performance criteria comprise at least one of: minimization of startup time, minimization of operating costs, minimization of emissions, maximization of plant operability and availability.

6. The system according to claim 1, wherein the controller operates according to model predictive control.

7. The system according to claim 1, wherein the optimizer comprises an online optimizer.

8. The system according to claim 1, wherein the power plant comprises a combined cycle power plant.

9. The system according to claim 1, wherein the power plant comprises a fossil power plant.

10. The system according to claim 1, wherein the power plant comprises a nuclear power plant.

11. A method for controlling a power plant, comprising:
building a model for a plurality of power plant components, the model being capable of predicting behavior of the plurality of power plant components;
capturing dynamics and a plurality of constraints of each of the plurality of power plant components using a plurality of parameters;
using an optimization algorithm to generate a plurality of optimal input profiles for the plurality of components of the power plant that satisfies the constraints in the plant to optimize performance criteria for the plurality of power plant components;
receiving inputs corresponding to operational parameters of the power plant components; and
optimizing performance criteria of the power plant according to the model.

12. The method according to claim 11, wherein the controlling comprises model predictive controlling.

13. The method according to claim 11, wherein building a model comprises building a plurality of physics-based models.

14. The method according to claim 11, wherein the plurality of constraints comprise at least one of: mechanical constraints, thermal constraints, stresses, thrust force at a plurality of bearings, actuator saturation, radial clearances between a plurality of rotating and stationary parts, differential expansion between a plurality of adjoining parts or maintenance of at least one of: steam quality, water level in boilers, steam temperature, metal temperature or steam pressure at a plurality of locations in the power plant.

15. The method according to claim 11, wherein the performance criteria comprise at least one of: minimization of startup time, minimization of operating costs, minimization of emissions, maximization of plant operability and availability.

16. The method according to claim 11, wherein the inputs comprise at least one of: a quantity of fuel flow corresponding to one or more gas turbines or steam generation units, at least one parameter related to inlet guide vanes operation for the power plant corresponding to one or more gas turbines, at least one parameter related to a feed water or blow down valves operation in the heat recovery steam generator, at least one parameter related to valves' operation in a steam turbine, at least one parameter related to steam attemporation in the heat recovery steam generator, or at least one parameter related to vacuum pumps in the condenser.

17. The method according to claim 11, wherein the controlling comprises at least one of: disposing and communicating with a gas turbine controller, disposing and communicating with a steam turbine controller, disposing and communicating with a heat recovery steam generator controller, communicating with the gas turbine controller using a standalone processor, communicating with the steam turbine controller using a standalone processor or communicating with the heat recovery system generator controller using a standalone processor.

18. The method according to claim 11, wherein receiving inputs comprises disposing a plurality of sensors coupled to each of the plurality of components of the power plant to communicate the inputs corresponding to the operational parameters of the power plant component to the controller.

19. The method according to claim 11, wherein optimizing performance criteria of the power plant comprises:
updating the model to reflect the current state of the plurality of components of the power plant;
comparing the current state of the plurality of components of the power plant with model data about the plurality of components of the power plant;
determining an optimal corrective control action to take given the current state of the plurality of components of the power plant, the performance criteria of the power plant, and the input profiles of the plurality of components of the power plant;
sending a control command to implement the optimal corrective control action; and
repeating above steps as necessary to continue to optimize the performance criteria of the power plant.

20. The method according to claim 11, wherein the optimization algorithm comprises an online optimization algorithm.

21. The method according to claim 11, wherein the optimization algorithm solves a quadratic programming problem or a linear programming problem.

22. The method according to claim 21, wherein the optimization algorithm employs an interior point method or an active set method.

23. The method according to claim 11, wherein optimizing performance criteria of the power plant comprises configuring the optimization algorithm to adapt to varying optimization problems.

24. The method according to claim 23, wherein configuring comprises defining a maximum number of iterations to be performed by the optimization algorithm.

25. The method according to claim 23, wherein the varying optimization problems comprises using optimization algorithms with at least one of: varying prediction horizon, varying maximum stress levels, varying target power level, varying model linearization rate of the model, varying number of gas turbines and/or steam generation units that provide steam to the same steam turbine.

26. The method according to claim 11, wherein controlling further comprises customizing by generating at least one of: optimum loading or optimum unloading profiles from an initial load to a final load.

27. The method according to claim 11 further comprising employing patterns of data to manipulate the model and generate the optimization problem with minimum memory requirements and associated computational efforts.

28. The method according to claim 27 wherein the patterns of data comprise sparsity structures.

29. A method for controlling a power plant, comprising:
building a model for a plurality of power plant components, wherein the model captures dynamics and a plurality of constraints of each of the plurality of power plant components using a plurality of parameters, the model being capable of predicting behavior of the plurality of power plant components;
disposing an optimizer that is adapted to receive inputs corresponding to operational parameters of the power plant components, to employ the inputs to generate optimal input profiles of the plurality of plant components that satisfy the plurality of constraints, and to optimize performance criteria for the plurality of plant components.

30. The method according to claim 29, wherein the model comprises a plurality of physics-based models.

31. The method according to claim 29, wherein the controller comprises at least one of: a gas turbine controller, a steam turbine controller, a steam generator controller, a standalone processor communicating with the gas turbine controller, a standalone processor communicating with the steam turbine controller or a standalone processor communicating with the heat recovery method generator controller.

32. The method according to claim 29, wherein the controller comprises a real-time controller.

33. The method according to claim 29 further comprising disposing a plurality of sensors to communicate the inputs corresponding to the operational parameters of the power plant component to the controller.

34. The method according to claim 29, wherein the controller is based on model predictive control.

35. The method according to claim 34, wherein maximum of iterations performed by the controller is configurable to adapt to a plurality of optimization algorithms.
